(19) United States
(12) Patent Application Publication
(10) Pub. No.: US 2016/0117922 A1
(43) Pub. Date: Apr. 28, 2016

(54) DISPLAY SYSTEM OF VEHICLE AND METHOD OF CONTROLLING THE DISPLAY SYSTEM

(71) Applicant: HYUNDAI MOTOR COMPANY, Seoul (KR)

(72) Inventor: Se Min OH, Seoul (KR)

(21) Appl. No.: 14/924,403

(22) Filed: Oct. 27, 2015

(30) Foreign Application Priority Data
Oct. 28, 2014 (KR) 10-2014-0147261

(51) Int. Cl. G08G 1/0962; G01C 21/36; B60K 35/00; G06K 9/00; H04N 7/18

(52) U.S. Cl. CPC G08G 1/09623; G06K 9/00818; H04N 7/183; G06K 9/00798; B60K 35/00; G01C 21/3667

(57) ABSTRACT

A vehicle includes a control unit configured to control a first display unit not to display a first speed limit and to control a second display unit to display a second speed limit when speed limit display function of the first display unit is deactivated and a traffic information detection function of a traffic information detection unit is performed, and to control the second display unit to display the first speed limit instead of the second speed limit when the first speed limit differs from the second speed limit. It is possible to provide up-to-date accurate traffic information by allowing a traffic information detection function and navigation of the vehicle to interwork with each other.

### CROSS-REFERENCE TO RELATED APPLICATION

This application claims priority to and the benefit of Korean Patent Application No. 10-2014-0147261, filed on Oct. 28, 2014 in the Korean Intellectual Property Office, the disclosure of which is incorporated herein by reference.

### TECHNICAL FIELD

Embodiments of the present invention relate to a vehicle, and more particularly, to traffic information display control in a vehicle.

### BACKGROUND

It is very important to display traffic information to a user, that is, a driver, of a vehicle in order to provide safety and convenience in driving.

For example, as representative traffic information display of a vehicle, a speed limit is displayed on map data in navigation to allow the driver to drive safely at a safe speed. However, in the case of navigation, up-to-date traffic information may be provided only when a map and traffic information of the navigation are updated. When an update interval of the map and traffic information of the navigation is long, a user may not receive up-to-date traffic information, which may cause a user to be dissatisfied with respect to driving safety and driver convenience.

### SUMMARY

Therefore, it is an aspect of the present invention to provide constant up-to-date accurate traffic information by allowing a traffic information detection function and navigation of a vehicle to interwork with each other.

Additional aspects of the invention will be set forth in part in the description which follows and, in part, will be obvious from the description, or may be learned by practice of the invention.

In accordance with one aspect of the present invention, a display system includes a traffic information detection unit configured to take images of surroundings of a vehicle and detect a first speed limit on a road from the taken images, a first display unit configured to display the first speed limit, a second display unit configured to display a second speed limit of map data of navigation, a speed limit display setting unit configured to activate or deactivate a speed limit display function of the first display unit, and a control unit configured to control the first display unit not to display the first speed limit and to control the second display unit to display the second speed limit when the speed limit display function of the first displaying unit is deactivated and a traffic information detection function of the traffic information detection unit is performed, and to control the second display unit to display the first speed limit instead of the second speed limit when the first speed limit differs from the second speed limit.

The control unit may control the first display unit to display the first speed limit and may control the second display unit to display the second speed limit when the speed limit display function is activated and the traffic information detection function is performed, and may control the second display unit to display the first speed limit instead of the second speed limit when the first speed limit differs from the second speed limit.

The control unit may control the first display unit to display that the traffic information detection function is not performed and may control the second display unit to display the second speed limit when the speed limit display function is activated and the traffic information detection function is not performed.

The control unit may control the first display unit to display that the traffic information detection function is not performed and may control the second display unit to display the second speed limit when the speed limit display function is activated and the traffic information detection function is not performed.

The first speed limit may be obtained by recognizing a speed limit on a traffic sign located on the periphery of the vehicle.

The traffic information detection unit may include a camera configured to take a picture of surroundings of the vehicle and an information processing unit configured to read out information shown on the traffic sign on the periphery of the vehicle from images taken by the camera.

The first display unit may be a cluster displaying state information of the vehicle.

The second display unit may be a display of the navigation.

In accordance with another aspect of the present invention, a method of controlling a display system of a vehicle, the display system including a traffic information detection unit configured to take images of surroundings of a vehicle and detect a first speed limit on a road from the taken images, a first display unit configured to display the first speed limit, a second display unit configured to display a second speed limit of map data of navigation, and a speed limit display setting unit configured to activate or deactivate a speed limit display function of the first display unit, the method includes not displaying the first speed limit on the first display unit and displaying the second speed limit on the second display unit when the speed limit display function of the first displaying unit is deactivated and a traffic information detection function of the traffic information detection unit is performed and displaying the first speed limit on the second display unit instead of the second speed limit when the first speed limit differs from the second speed limit.

The method may further include displaying the first speed limit on the first display unit and displaying the second speed limit on the second display unit when the speed limit display function is activated and the traffic information detection function is performed, wherein the first speed limit is displayed on the second display unit instead of the second speed limit when the first speed limit differs from the second speed limit.

The method may further include displaying, on the first display unit, that the traffic information detection function is not performed and displaying the second speed limit on the second display unit when the speed limit display function is activated and the traffic information detection function is not performed.

The first speed limit may be obtained by recognizing a speed limit on a traffic sign located on the periphery of the vehicle.

The traffic information detection unit may include a camera configured to take a picture of surroundings of the vehicle and an information processing unit configured to read out information shown on the traffic sign on the periphery of the vehicle from images taken by the camera.

The first display unit may be a cluster displaying state information of the vehicle.

The second display unit may be a display of the navigation.

In accordance with still another aspect of the present invention, a vehicle includes a traffic information detection unit configured to take images of surroundings of a vehicle and detect a first speed limit on a road from the taken images, a first display unit configured to display the first speed limit, a second display unit configured to display a second speed limit of map data of navigation, a speed limit display setting unit configured to activate or deactivate a speed limit display function of the first display unit, and a control unit configured to perform a plurality of control modes for controlling the first display unit to display the first speed limit and controlling the second display unit to display the second speed limit, in which the plurality of control modes include a first mode in which the first display unit displays the first speed limit and the second display unit displays the second speed limit when the speed limit display function is activated and a traffic information detection function is performed, and the first speed limit is displayed on the second display unit instead of the second speed limit when the first speed limit differs from the second speed limit, a second mode in which the first display unit displays that the traffic information detection function is not performed and the second display unit displays the second speed limit when the speed limit display function is activated and the traffic information detection function is not performed, a third mode in which the first display unit does not display the first speed limit and the second display unit displays the second speed limit when the speed limit display function is deactivated and the traffic information detection function is performed, and the first speed limit is displayed on the second display unit instead of the second speed limit when the first speed limit differs from the second speed limit, and a fourth mode in which the first display unit displays that the traffic information detection function is not performed and the second display unit displays the second speed limit when the speed limit display function is activated and the traffic information detection function is not performed.

In accordance with yet another aspect of the present invention, there is provided a method of controlling a vehicle including a traffic information detection unit configured to take images of surroundings of a vehicle and detect a first speed limit on a road from the taken images, a first display unit configured to display the first speed limit, a second display unit configured to display a second speed limit of map data of navigation, and a speed limit display setting unit configured to activate or deactivate a speed limit display function of the first display unit. The method includes displaying the first speed limit on the first display unit and displaying the second speed limit on the second display unit when the speed limit display function is activated and a traffic information detection function is performed, and displaying the first speed limit on the second display unit instead of the second speed limit when the first speed limit differs from the second speed limit, displaying, on the first display unit, that the traffic information detection function is not performed and displaying the second speed limit on the second display unit when the speed limit display function is activated and the traffic information detection function is not performed, not displaying the first speed limit on the first display unit and displaying the second speed limit on the second display unit when the speed limit display function is deactivated and the traffic information detection function is performed, and displaying the first speed limit on the second display unit instead of the second speed limit when the first speed limit differs from the second speed limit, and displaying, on the first display unit, that the traffic information detection function is not performed and displaying the second speed limit on the second display unit when the speed limit display function is activated and the traffic information detection function is not performed.

In accordance with yet another aspect of the present invention, there is provided a vehicle including a traffic information detection unit configured to capture images of surroundings of the vehicle and obtain a first speed limit on a road from the captured images, a navigation system configured to determine a position of the vehicle, and a second speed limit of map data stored in the navigation system corresponding to the determined position of the vehicle, a first display unit configured to display or not display the first speed limit, a second display unit configured to selectively display one of the first and second speed limits, and a control unit configured to control the second display unit to display the first speed limit when the first speed limit differs from the second speed limit.

The vehicle may further include a speed limit display setting unit configured to activate or deactivate a speed limit display function of the first display unit. The first display unit may display the first speed limit upon the activation of the speed limit display function, and the first display unit may not display the first speed limit upon deactivation of the speed limit display function.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a driving state of a vehicle in accordance with one embodiment of the present invention;

FIG. 2 is a view illustrating the inside of the vehicle in accordance with one embodiment of the present invention;

FIGS. 3A and 3B are views illustrating display of a speed limit in the vehicle using recognition of a traffic sign;

FIG. 4 is a view illustrating a control system of the vehicle in accordance with one embodiment of the present invention;

FIG. 5 is a view illustrating a configuration of a traffic information detection unit shown in FIG. 4;

FIG. 6 is a view illustrating an AVN of the vehicle in accordance with one embodiment of the present invention;

FIG. 7 is a view illustrating a speed limit display state of the vehicle in accordance with one embodiment of the present invention;

FIGS. 8A, 8B, and 8C are views respectively illustrating a set mode, displayed information by a cluster, and displayed information by an AVN, corresponding to a first mode in FIG. 7;

FIGS. 9A, 9B, and 9C are views illustrating a set mode, displayed information by a cluster, and displayed information by an AVN, corresponding to a second mode in FIG. 7;

FIGS. 10A, 10B, and 100 are views illustrating a set mode, displayed information by a cluster, and displayed information by an AVN, corresponding to a third mode in FIG. 7;

FIGS. 11A, 11B, and 11C are views illustrating a set mode, displayed information by a cluster, and displayed information by an AVN, corresponding to a fourth mode in FIG. 7; and

FIGS. 12A and 12B are views illustrating a method of controlling the vehicle in accordance with one embodiment of the present invention.

### DETAILED DESCRIPTION

Reference will now be made in detail to embodiments of the present invention, examples of which are illustrated in the accompanying drawings, wherein like reference numerals refer to like elements throughout.

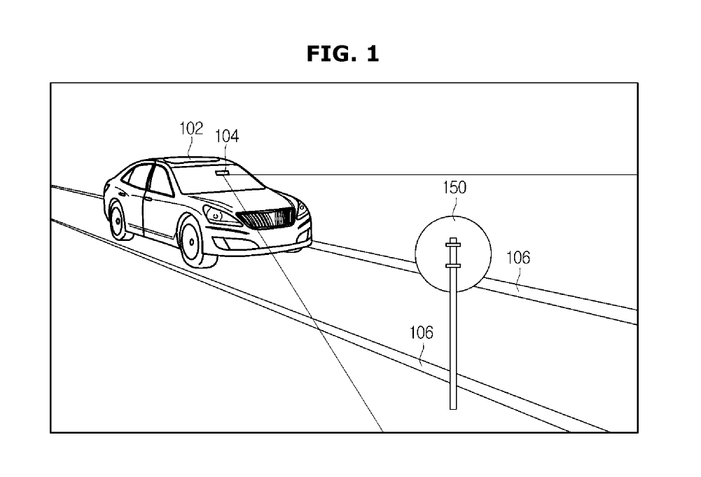

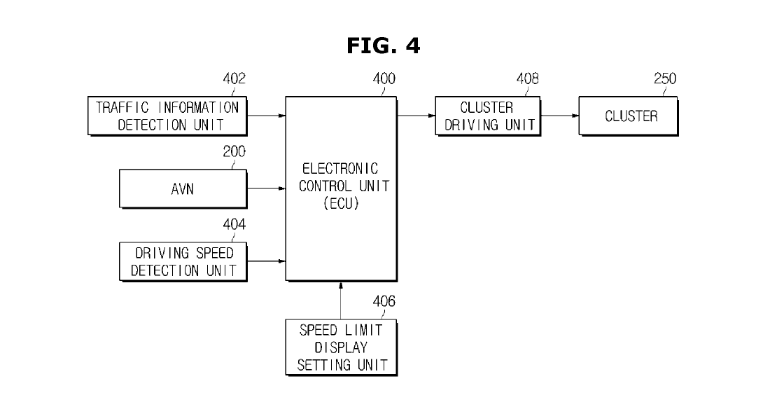

FIG. 1 is a view illustrating a driving state of a vehicle 102 in accordance with one embodiment of the present invention. As shown in FIG. 1, the vehicle 102 includes a camera 104 capable of taking a picture of surroundings thereof. The camera 104 is an element forming a traffic information detection unit (402, refer to FIG. 4) that will be described later. An image taken by the camera 104 is used to recognize a lane 106 shown on a road and to recognize traffic information such as a speed limit shown on a traffic sign 150 located on the periphery of the vehicle 102.

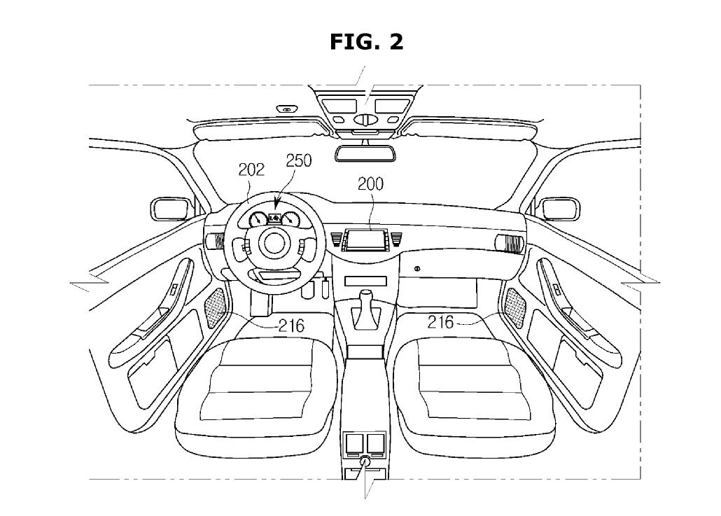

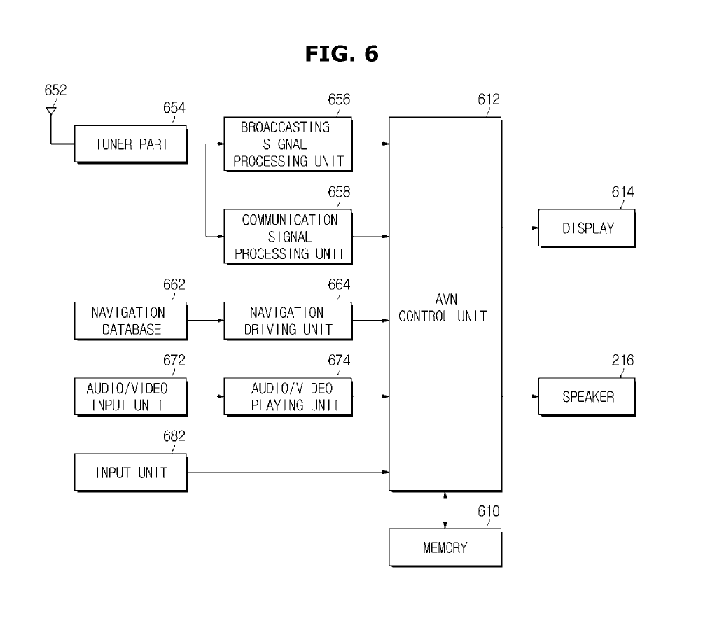

FIG. 2 is a view illustrating the inside of a vehicle in accordance with one embodiment of the present invention. As shown in FIG. 2, an audio-video navigation (AVN) 200 and a steering wheel 202 are installed in front of a driver's seat. In the AVN 200, audio, video, and navigation are integrated, and a display (614, refer to FIG. 6) is included. Speakers 216 are installed on a door on the left of the driver's seat and a door on the right of a passenger seat. A cluster 250 is provided in front of the steering wheel 202. On the cluster 250, various pieces of driving state information of the vehicle 102 are displayed.

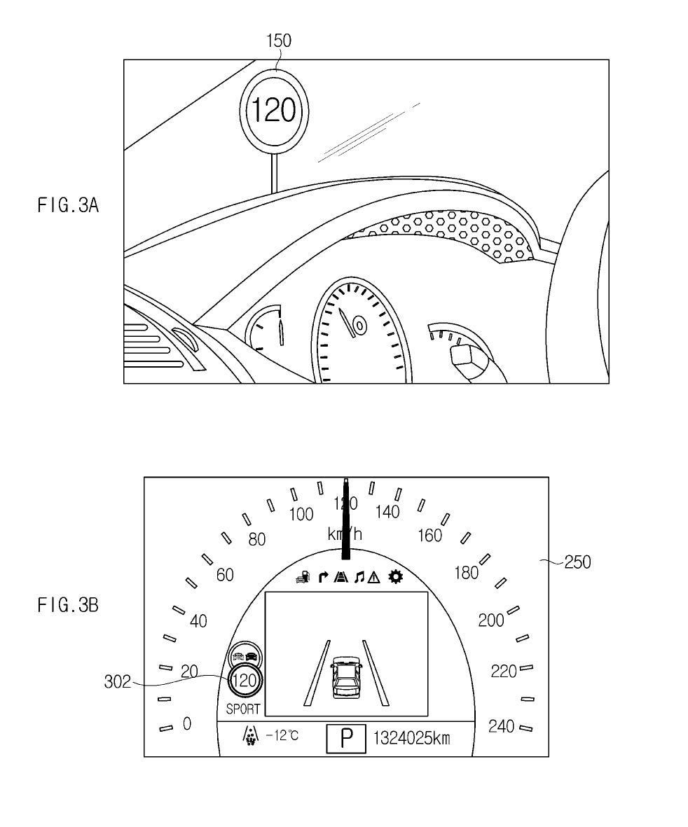

FIGS. 3A and 3B are views illustrating display of a speed limit in the vehicle using recognition of a traffic sign. As shown in FIG. 3A, the traffic information detection unit 402 of the vehicle 102 recognizes a speed limit (120 km/h or less in FIG. 3A) from the traffic sign 150 located outside the vehicle 102. The speed limit recognized by the traffic information detection unit 402, as shown in FIG. 3B, is displayed on the cluster 250 as a first speed limit 302, which is recognized by the traffic information detection unit 402. The speed limit displayed on the cluster 250 may or may not be displayed depending on user settings.

FIG. 4 is a view illustrating a control system of a vehicle in accordance with one embodiment of the present invention. As shown in FIG. 4, the traffic information detection unit 402, the AVN 200, a driving speed detection unit 404, and a speed limit display setting unit 406 are communicably connected to an input part of an electronic control unit 400 and the cluster 250 is communicably connected to an output part of the electronic control unit 400 through a cluster driving unit 408.

The traffic information detection unit 402 described briefly with reference to FIG. 1 will be described in detail next. The traffic information detection unit 402 takes pictures of surroundings of the vehicle 102 and analyzes taken images, thereby obtaining various pieces of traffic information on the road, for example, information on the lane 106 and the traffic sign 150.

The lane 106 is recognized in order to issue a warning when the vehicle 102 deviates from the road while driving or to control a direction of the vehicle 102 such that the vehicle 102 does not deviate from the road when the vehicle 102 is about to deviate from the road.

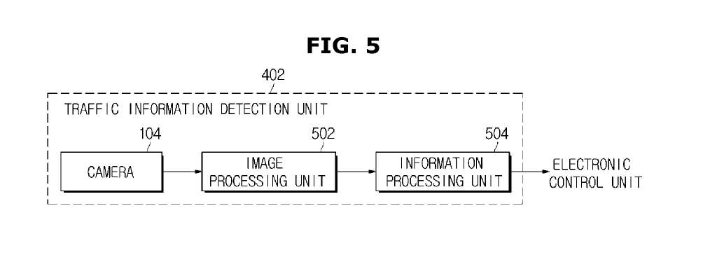

Also, recognition of the traffic sign 150 is to obtain various pieces of traffic information on the road where the vehicle 102 drives. For example, the traffic sign 150 may be a speed limit sign indicating the maximum speed limit. An information processing unit (504, refer to FIG. 5) reads a speed limit indicated on the traffic sign 150 by analyzing a taken image of the traffic sign 150 and provides a result to the electronic control unit 400.

The AVN 200 in which audio, video, and navigation are integrated basically displays a speed limit of map data of the navigation on a display (614, refer to FIG. 6) in a navigation mode. Also, traffic information, for example, a speed limit detected by the traffic information detection unit 402, may be displayed on the display 614 in a particular situation under control of the electronic control unit 400.

The driving speed detection unit 404 detects and transmits a present driving speed of the vehicle 102 to the electronic control unit 400.

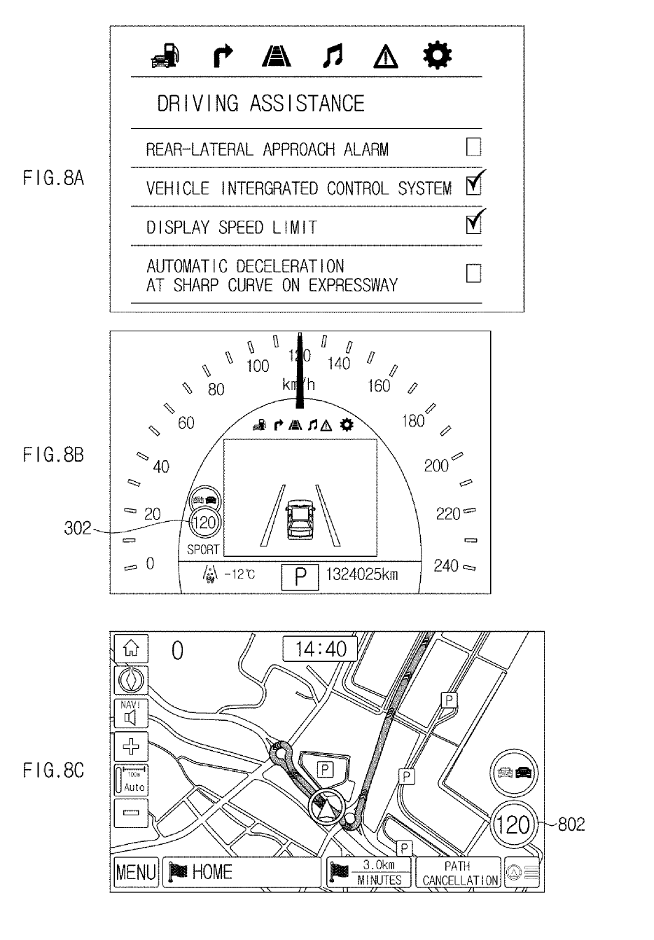

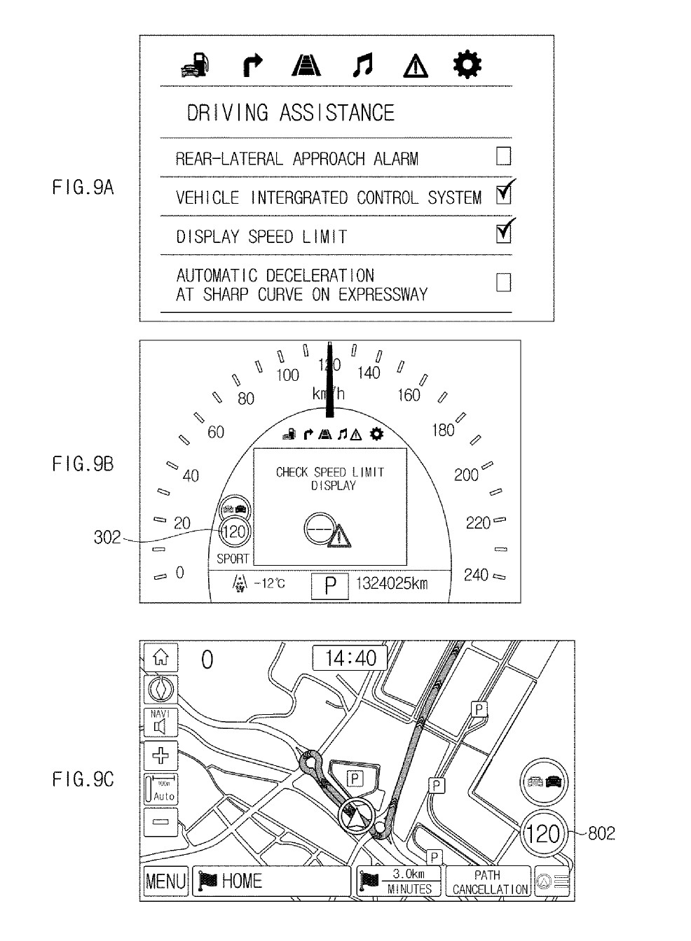

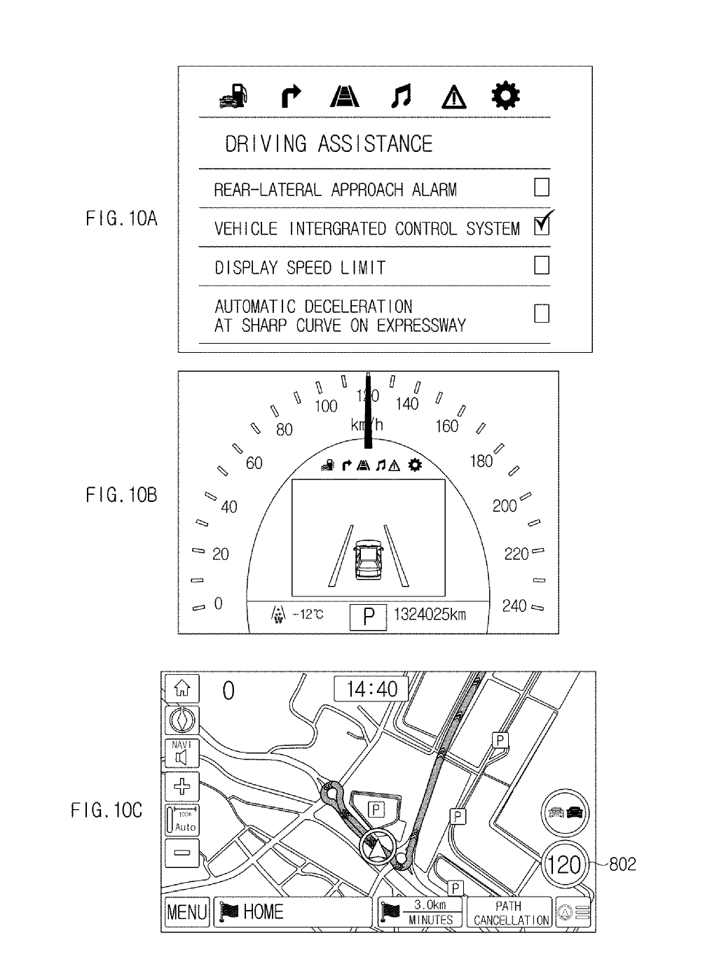

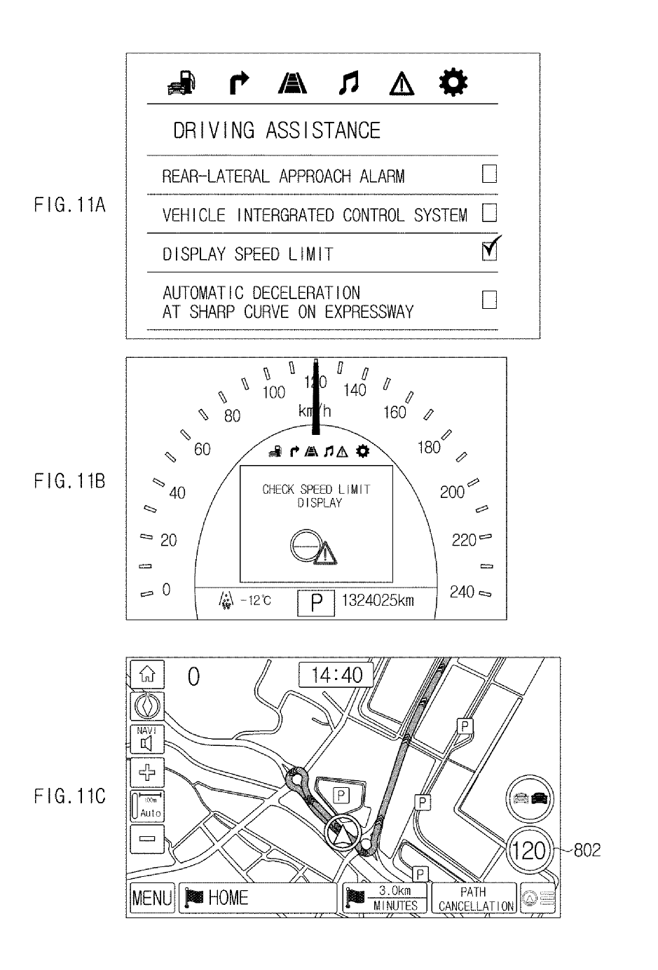

The speed limit display setting unit 406 sets whether or not to display a speed limit on the cluster 250. For this, the speed limit display setting unit 406 may be provided as a graphic user interface on the display 614 of the AVN 200. For example, when a check box of a corresponding item displayed on the display 614 is checked (SLIF ON), an actual speed limit on the road obtained by the traffic information detection unit 402 is displayed on the cluster 250 (refer to FIGS. 8A and 9A). SLIF ON, in which “SLIF” stands for “speed limit information function,” indicates a state in which a speed limit display function is activated. Also, when a check box of a corresponding item displayed on the display 614 is unchecked (SLIF OFF), the actual speed limit on the road obtained by the traffic information detection unit 402 is not displayed on the cluster 250 (refer to FIGS. 10A and 11A). SLIF OFF indicates a state in which the speed limit display function is deactivated.

On the cluster 250, various pieces of driving state information of the vehicle 102 are displayed. For example, a driving speed of the vehicle 102 and revolutions per minute (RPM) of the engine, a result of detecting the lane, and traffic information may be displayed. Particularly, on the cluster 250, a speed limit on an actual traffic sign obtained by the traffic information detection unit 402 may be selectively displayed. It is determined depending on a setting value (SLIF ON/OFF) of the speed limit display setting unit 406 whether to display the speed limit on the cluster 250. When the speed limit is set to be displayed by the speed limit display setting unit 406 (SLIF ON), the speed limit is displayed on the cluster 250. When the speed limit is set not to be displayed by the speed limit display setting unit 406 (SLIF OFF), the speed limit is not displayed on the cluster 250. The cluster 250 described above is driven by the cluster driving unit 408. The cluster driving unit 408 receives a control signal from the electronic control unit 400 and drives the cluster 250.

The electronic control unit (ECU, 400), as a representative control unit, controls overall operations of the vehicle 102. Particularly, when a speed limit is displayed on one of the cluster 250 and the display 614 of the AVN 200, depending on a combination of the speed limit display settings, that is, SLIF ON or SLIF OFF and a state of the traffic information detection unit 402, that is, normal or abnormal, traffic information display is controlled to effectively provide a user with traffic information. The traffic information display control of the electronic control unit 400 will be described later.

FIG. 5 is a view illustrating a configuration of the traffic information detection unit 402. As shown in FIG. 5, the traffic information detection unit 402 includes the camera 104, an image processing unit 502, and the information processing unit 504.

The camera 104 takes a picture of surroundings of the vehicle 102. For example, the camera 104 may take a picture of the lane 106 or the traffic sign 150 located on the periphery of the vehicle 102.

The image processing unit 502 adjusts an image to improve quality thereof.

The information processing unit 504 detects the lane 106 (refer to FIG. 1) in front of the vehicle 102 from images taken by the camera 104. Also, the information processing unit 504 detects the traffic sign 150 (refer to FIG. 1) in front of the vehicle 102 from images taken by the camera 104. For example, the traffic sign 150 may be a speed limit sign indicating the maximum speed limit. The information processing unit 504 reads a speed limit indicated on the traffic sign 150 by analyzing a taken image of the traffic sign 150 and provides a result to the electronic control unit 400.

FIG. 6 is a view illustrating the AVN 200. As shown in FIG. 2, a configuration of the AVN 200 may be divided into a component for a general input function, a component for a broadcasting/communication function, a component for a navigation function, a component for an audio/video function, and a component used for a plurality of functions in common.

The component for the broadcasting/communication function includes an antenna 652, a tuner part 654, a broadcasting signal processing unit 656, and a communication signal processing unit 658. The component for the navigation function includes a navigation database 662 and a navigation driving unit 664. The component for the audio/video function includes an audio/video input unit 672 and an audio/video playing unit 674. The component for the general input function includes an input unit 682. The component for the plurality of functions in common includes a memory 610, a control unit 612, the display 614, and the speaker 216. The classification depending on function described above is not limited thereto, but a component for any one function may be used for another function.

The antenna 652 is a device for receiving or transmitting radio waves through the air in order to receive broadcasting signals and to receive or transmit communication signals. The antenna 652 is communicably connected to the tuner part 654. Accordingly, radio waves received by the antenna 652 are transmitted to the tuner part 654. The antenna 652 may be formed in plural for a plurality of broadcasting/communication signals having mutually different forms.

The tuner part 654 converts radio waves received by the antenna 652 into intermediate frequency signals. Also, the tuner part 654 converts a data signal to be transmitted into a form capable of propagating through the air to be transmitted through the air via the antenna 652. That is, the tuner part 654 extracts signals in a certain band or combines a carrier signal with a data signal. The tuner part 654 receives broadcasting signals and transmits and receives communication signals. Broadcasting signals may include radio broadcasting signals and digital multimedia broadcasting (DMB) signals. Communication signals may include satellite communication signals with a Global Positioning System (GPS) satellite. Also, communication signals may include communication signals for telematics. It is determined according to a control signal transmitted from the control unit 612 to the tuner part 654 which signal is to be received and processed by the tuner part 654. For example, when a control signal is transmitted form the control unit 612 to the tuner part 654 to receive radio broadcasting signals of a certain channel, the tuner part 654 receives radio broadcasting signals of the corresponding channel in response to the control signal transmitted from the control unit 612. When the control unit 612 transmits a control signal for transmitting a telematics signal and transmission data to the tuner part 654, the tuner part 654 converts the transmission data into a form capable of being transmitted through to air and transmits a converted signal through the air via the antenna 652. Also, the tuner part 654 obtains information of a broadcasting channel included in broadcasting signals. Broadcasting signals input into the tuner part 654 include a title of a broadcasting channel, service identification (ID), and broadcasting data. The tuner part 654 extracts and transmits the title of the broadcasting channel, the service ID, and broadcasting data included in the broadcasting signals to the broadcasting signal processing unit 656 and the control unit 612.

The broadcasting signal processing unit 656 classifies broadcasting signals passing through the tuner part 654 into video broadcasting signals and audio broadcasting signals and performs a series of signal processing. The series of signal processing performed by the broadcasting signal processing unit 656 may include analog-digital conversion, digital-analog conversion, and conversion from video data into signals having a form capable of driving the display 614.

The communication signal processing unit 658 processes communication signals with the GPS satellite and telematics-based communication signals. That is, the communication signal processing unit 658 converts received communication signals into a form of data for being transmitted to the control unit 612 or receives and converts data to be transmitted through the tuner part 654 and the antenna 652 from the control unit 612 into signals having a communicable form.

The navigation database 662 includes data for performing navigation. The navigation database 662 may have a form of one of a memory card and a Digital Versatile Disc (DVD). Also, navigation data provided from a mobile terminal connected through a wired/wireless link such as CarPlay or Android Auto may be used as a navigation database.

The navigation driving unit 664 forms a navigation screen on the display 614 using data provided from the navigation database 662. For this, navigation setting information such as a destination and stops set by the user and a route is provided from the control unit 612. Also, present location information of the vehicle 102 obtained through communication with the GPS satellite to perform navigation is provided from the control unit 612.

The audio/video input unit 672 may be an optical disc drive (ODD). Also, the audio/video input unit 672 may be one of a Universal Serial Bus (USB) input device and an auxiliary input/output terminal called AUX. Otherwise, the audio/video input unit 672 may be a Bluetooth device for wireless connection with a mobile terminal. The mobile terminal connected to the audio/video input unit 672 through Bluetooth may be one of a cellular phone and a portable digital music player.

The audio/video playing unit 674 allows audio/video data input through the audio/video input unit 672 to be output to one of the speaker 216 and the display 614. For example, when the audio/video input unit 672 is an ODD, the ODD reads out and extracts audio/video data recorded on an optical disc such as a compact disc (CD), a DVD, and a Blu-ray Disc (BD), the audio/video playing unit 674 converts the audio/video data extracted by the audio/video input unit 672 into signals having a form capable of driving one of the speaker 216 and the display 614 to play the audio/video data. Audio/video data provided on other media in addition to ODDs may be converted into signals having the form capable of driving one of the speaker 216 and the display 614 through the audio/video playing unit 674.

The input unit 682 may be one of at least one button provided on the AVN 200 and a touch screen provided on the display 614. A driver may select one of multiple functions of the AVN 200 by operating the input unit 682 and may add various settings to perform an operation expected from the selected function. A voice recognition button of the steering wheel 202 may be included in the at least one button forming the input unit 682.

The control unit 612 is involved in overall operations of the AVN 200 and performs necessary control. For example, the control unit 612 may process broadcasting/communication signals. When audio/video data generated after processing broadcasting/communication signals is to be output to one of the speaker 216 and the display 614, corresponding audio/video data is controlled to be transmitted to one of the speaker 216 and the display 614, thereby allowing the output of necessary audio/video data. Also, when the driver selects a navigation function, the control unit 612 controls the navigation database 662, the navigation driving unit 664, the display 614, and the speaker 216 to perform navigation. Also, the control unit 612 controls audio/video data input through the audio/video input unit 672 to be played by the audio/video playing unit 674 and transmitted to one of the speaker 216 and the display 614, thereby allowing the output of necessary audio/video data.

The memory 610 stores various applications executed to perform each of the broadcasting/communication function, the navigation function, and the audio/video function of the AVN 200, and screen display data, voice data, and sound effect data necessary to execute applications.

The display 614 outputs video that accompanies execution of multiple functions such as the broadcasting/communication function, the navigation function, and the audio/video function of the AVN 200. For example, a guide screen, messages, and video data for each function are output through the display 614.

The speaker 216 outputs audio that accompanies execution of multiple functions such as the broadcasting/communication function, the navigation function, and the audio/video function of the AVN 200. For example, guide comments, sound effects, and audio data for each function are output through the speaker 216.

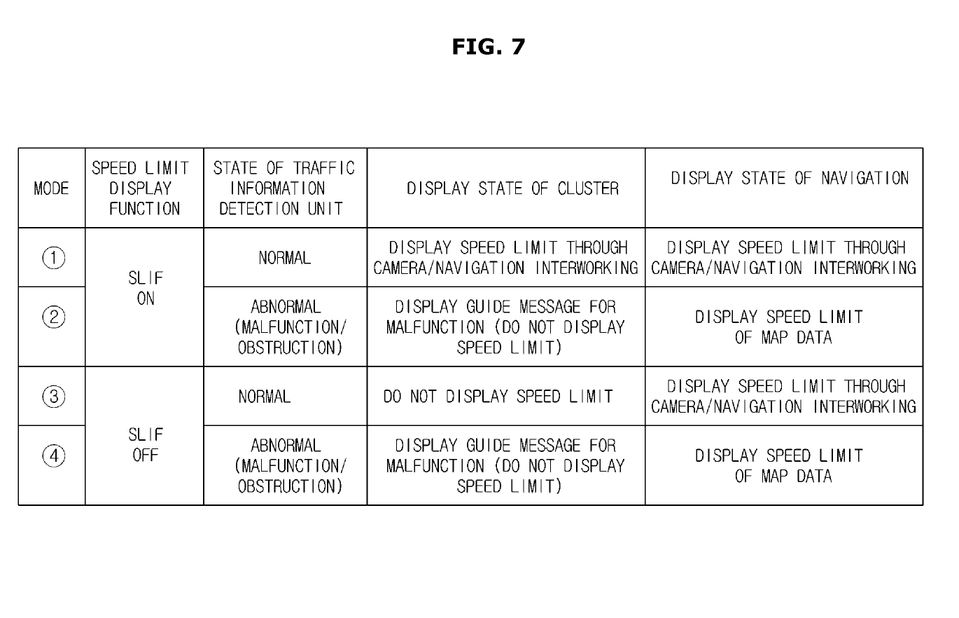

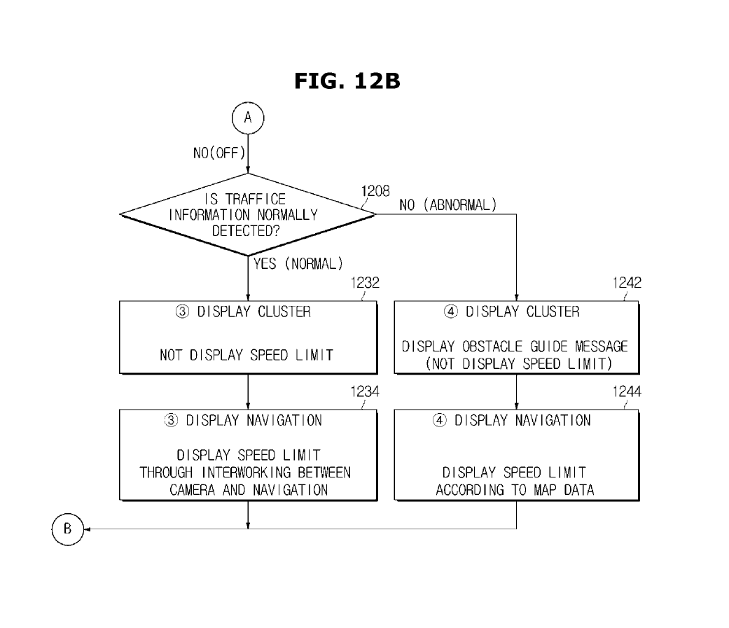

FIG. 7 is a view illustrating a speed limit display state of the vehicle 102 in accordance with one embodiment of the present invention. In the vehicle 102, depending on speed limit display settings by the user and whether the function of the traffic information detection unit 402 operates normally, the electronic control unit 400 controls a speed limit to be displayed on each of the cluster 250 and the display 614 in various forms such as a first mode to a fourth mode shown in FIG. 7. For example, FIGS. 8A, 8B, and 8C are views respectively illustrating a set mode, displayed information by the cluster, and displayed information by the AVN, corresponding to the first mode in FIG. 7. FIGS. 9A, 9B, and 9C are views illustrating the set mode, displayed information by the cluster, and displayed information by the AVN, corresponding to the second mode in FIG. 7. FIGS. 10A, 10B, and 100 are views illustrating the set mode, displayed information by the cluster, and displayed information by the AVN, corresponding to the third mode in FIG. 7. FIGS. 11A, 11B, and 110 are views illustrating the set mode, displayed information by the cluster, and displayed information by the AVN, corresponding to the fourth mode in FIG. 7 First mode: SLIF ON & normal camera state (refer to FIGS. 8A-8C)

In the first mode, the electronic control unit 400 controls the cluster 250 and the display 614 to display a speed limit as follows.

Cluster display state: Display speed limit through interworking between camera and navigation

Since the SLIF is ON and the camera 104 operates normally, the electronic control unit 400 displays a speed limit on the traffic sign 150 detected by the traffic information detection unit 402 on the cluster 250.

Navigation display state: Display speed limit through interworking between camera and navigation

On the display 614 of the AVN 200 performing the navigation function, a speed limit 802 of map data of navigation is displayed. However, when the speed limit on the traffic sign 150 on the road detected by the traffic information detection unit 402 differs from the speed limit on the map data of navigation, the speed limit on the traffic sign 150 is preferentially displayed. Since the navigation may not reflect an actual speed limit on the road depending on an update interval, the actual speed limit on the traffic sign 150 is given priority, thereby providing the user with more accurate speed limit information.

Second mode: SLIF ON & abnormal camera state (malfunction/obstruction, refer to FIGS. 9A-9C)

In the second mode, the electronic control unit 400 controls the cluster 250 and the display 614 to display a speed limit as follows.

Cluster display state: Display malfunction guide message (do not display speed limit)

Although the SLIF is ON, when the traffic information detection unit 402 does not operate normally, the electronic control unit 400 displays a guide message indicating that the traffic information detection unit 402 does not operate normally, on the cluster 250. Examples of cases in which the traffic information detection unit 402 does not operate normally include a case in which the camera 104 is out of order and a case in which it is impossible to take a picture of the traffic sign 150 on the road due to an obstacle on the periphery of the vehicle 102.

Navigation display state: Display speed limit of map data

On the display 614 of the AVN 200 performing the navigation function, a speed limit 802 of the map data of navigation is displayed.

Third mode: SLIF OFF & normal camera state (refer to FIGS. 10A-10C)

In the third mode, the electronic control unit 400 controls the cluster 250 and the display 614 to display a speed limit as follows.

Cluster display state: Do not display speed limit

Since the SLIF is OFF, the electronic control unit 400 does not display a speed limit on the cluster 250.

Navigation display state: Display speed limit through interworking between camera and navigation

On the display 614 of the AVN 200 performing the navigation function, a speed limit 802 of the map data of navigation is displayed. However, although the

SLIF is OFF and the speed limit is not displayed on the cluster 250, since speed limit detection of the traffic information detection unit 402 through recognition of the traffic sign 150 is performed normally, one of the speed limit on the traffic sign 150 detected by the traffic information detection unit 402 and the speed limit of map data may be selectively displayed on the display 614 of the AVN 200.

Basically, the speed limit on the traffic sign 150 detected by the traffic information detection unit 402 is preferentially displayed on the display 614 of the AVN 200. When there is no traffic sign detected by the traffic information detection unit 402 for a certain driving distance such as 10 km, it is determined that the traffic sign 150 cannot be recognized due to surroundings of the road such as obstacles or trouble with the traffic information detection unit 402, and the speed limit of the map data is displayed on the display 614.

Since the navigation may not fully reflect actual traffic information on the road depending on an update interval of the map data or traffic information, it may be impossible to accurately inform the user of an actual speed limit on the traffic sign 150 on the road only using the speed limit of the map data. Accordingly, although the SLIF is OFF, when the traffic information detection unit 402 is operating normally, information on the actual speed limit on the traffic sign 150 on the road detected by the traffic information detection unit 402 is preferentially displayed on the display 614 over the speed limit of the map data of navigation, thereby providing more accurate speed limit information.

Fourth mode: SLIF OFF & abnormal camera state (malfunction/obstruction, refer to FIGS. 11A-11C)

In the fourth mode, the electronic control unit 400 controls the cluster 250 and the display 614 to display a speed limit as follows.

Cluster display state: Display malfunction guide message (do not display speed limit)

When the SLIF is OFF and the traffic information detection unit 402 does not operate normally, the electronic control unit 400 displays a guide message indicating that the traffic information detection unit 402 does not operate normally on the cluster 250. Examples of cases in which the traffic information detection unit 402 does not operate normally include a case in which the camera 104 is out of order and a case in which it is impossible to take a picture of the traffic sign 150 on the road due to an obstacle on the periphery of the vehicle 102.

Navigation display state: Display speed limit of map data

On the display 614 of the AVN 200 performing the navigation function, a speed limit 802 of map data of navigation is displayed.

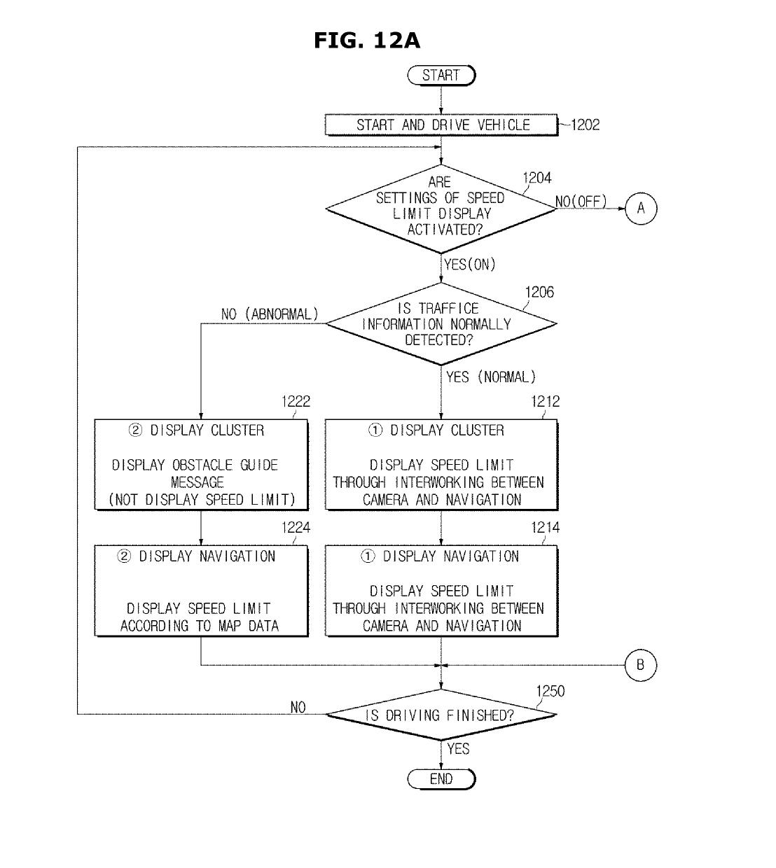

FIGS. 12A and 12B are views illustrating a method of controlling the vehicle 102 in accordance with one embodiment of the present invention. As shown in FIGS. 12A and 12B, when the user, that is, the driver, starts the vehicle 102 and begins driving, the electronic control unit 400 controls the vehicle 102 to drive safely (1202).

Particularly, the electronic control unit 400 displays a speed limit on one of the cluster 250 and the display 614 of the AVN 200 in various forms depending on a combination of speed limit display settings (SLIF ON or SLIF OFF) and a state (normal or abnormal) of the traffic information detection unit 402 (refer to 1204, 1206, and 1208).

That is, in the first mode (refer to FIGS. 8A-8C) in which the speed limit display settings are activated (YES for 1204) and the traffic information detection unit 402 operates normally (YES for 1206), the electronic control unit 400 controls the cluster 250 and the display 614 to display a speed limit as follows.

Cluster display state: Display speed limit through interworking between camera and navigation (1212)

Since the SLIF is ON and the camera 104 operates normally, the electronic control unit 400 displays a speed limit on the traffic sign 150 detected by the traffic information detection unit 402 on the cluster 250.

Navigation display state: Display speed limit through interworking between camera and navigation (1214)

On the display 614 of the AVN 200 performing the navigation function, a speed limit of map data of navigation is displayed. However, when the speed limit on the traffic sign 150 on the road detected by the traffic information detection unit 402 differs from the speed limit on the map data of navigation, the speed limit on the traffic sign 150 is preferentially displayed. Since the navigation may not reflect an actual speed limit on the road depending on an update interval, the actual speed limit on the traffic sign 150 is given priority, thereby providing the user with more accurate speed limit information.

In the second mode (refer to FIGS. 9A-9C) in which the speed limit display settings are activated (YES for 1204) and the traffic information detection unit 402 does not operate normally (NO for 1206), the electronic control unit 400 controls the cluster 250 and the display 614 to display a speed limit as follows.

Cluster display state: Display malfunction guide message (do not display speed limit, 1222)

Although the SLIF is ON, when the traffic information detection unit 402 does not operate normally, the electronic control unit 400 displays a guide message indicating that the traffic information detection unit 402 does not operate normally on the cluster 250. Examples of cases in which the traffic information detection unit 402 does not operate normally include a case in which the camera 104 is out of order and a case in which it is impossible to take a picture of the traffic sign 150 on the road due to an obstacle on the periphery of the vehicle 102.

Navigation display state: Display speed limit of map data (1224)

On the display 614 of the AVN 200 performing the navigation function, a speed limit of map data of navigation is displayed.

In the third mode (refer to FIGS. 10A-10C) in which the speed limit display settings are deactivated (NO for 1204) and the traffic information detection unit 402 operates normally (YES for 1208), the electronic control unit 400 controls the cluster 250 and the display 614 to display a speed limit as follows.

Cluster display state: Do not display speed limit (1232)

Since the SLIF is OFF, the electronic control unit 400 does not display a speed limit on the cluster 250.

Navigation display state: Display speed limit through interworking between camera and navigation interworking (1234)

On the display 614 of the AVN 200 performing the navigation function, a speed limit of map data of navigation is displayed. However, although the SLIF is OFF and the speed limit is not displayed on the cluster 250, since speed limit detection of the traffic information detection unit 402 through recognition of the traffic sign 150 is performed normally, one of the speed limit on the traffic sign 150 detected by the traffic information detection unit 402 and the speed limit of map data may be selectively displayed on the display 614 of the AVN 200.

Basically, the speed limit on the traffic sign 150 detected by the traffic information detection unit 402 is preferentially displayed on the display 614 of the AVN 200. When there is no traffic sign detected by the traffic information detection unit 402 for a certain driving distance such as 10 km, it is determined that the traffic sign 150 cannot be recognized due to surroundings of the road such as obstacles or trouble with the traffic information detection unit 402, and the speed limit of the map data is displayed on the display 614.

Since the navigation may not fully reflect actual traffic information on the road depending on an update interval of the map data or traffic information, it may be impossible to accurately inform the user of an actual speed limit on the traffic sign 150 on the road only using the speed limit of the map data. Accordingly, although the SLIF is OFF, when the traffic information detection unit 402 is operating normally, information on the actual speed limit on the traffic sign 150 on the road detected by the traffic information detection unit 402 is preferentially displayed on the display 614 over the speed limit of the map data of navigation, thereby providing more accurate speed limit information.

In the fourth mode in which the speed limit display settings are deactivated (NO) for 1204) and the traffic information detection unit 402 does not operate normally (NO for 1208), the electronic control unit 400 controls the cluster 250 and the display 614 to display a speed limit as follows.

Cluster display state: Display malfunction guide message (do not display speed limit, 1242)

When the SLIF is OFF and the traffic information detection unit 402 does not operate normally, the electronic control unit 400 displays a guide message indicating that the traffic information detection unit 402 does not operate normally on the cluster 250. Examples of cases in which the traffic information detection unit 402 does not operate normally include a case in which the camera 104 is out of order and a case in which it is impossible to take a picture of the traffic sign 150 on the road due to an obstacle on the periphery of the vehicle 102.

Navigation display state: Display speed limit of map data (1244)

On the display 614 of the AVN 200 performing the navigation function, a speed limit of map data of navigation is displayed.

The electronic control unit 400 repetitively performs a process from 1204 to 1244 until the driving of the vehicle 102 is finished (YES for 1250) (1250).

In accordance with one or more embodiments of the present invention, it is possible to constantly provide up-to-date accurate traffic information by allowing a traffic information detection function and navigation of a vehicle to interwork with each other.

Although a few embodiments of the present invention have been shown and described, it would be appreciated by those skilled in the art that changes may be made in these embodiments without departing from the principles and spirit of the invention, the scope of which is defined in the claims and their equivalents.

1. A display system comprising:
a traffic information detection unit configured to take images of surroundings of a vehicle and detect a first speed limit on a road from the taken images;
a first display unit configured to display the first speed limit;
a second display unit configured to display a second speed limit of map data of navigation;
a speed limit display setting unit configured to activate or deactivate a speed limit display function of the first display unit; and
a control unit configured to control the first display unit not to display the first speed limit and to control the second display unit to display the second speed limit when the speed limit display function of the first display unit is deactivated and a traffic information detection function of the traffic information detection unit is performed, and to control the second display unit to display the first speed limit instead of the second speed limit when the first speed limit differs from the second speed limit.

2. The display system of claim 1, wherein the control unit controls the first display unit to display the first speed limit and controls the second display unit to display the second speed limit when the speed limit display function is activated and the traffic information detection function is performed, and controls the second display unit to display the first speed limit instead of the second speed limit when the first speed limit differs from the second speed limit.

3. The display system of claim 1, wherein the control unit controls the first display unit to display that the traffic information detection function is not performed and controls the second display unit to display the second speed limit when the speed limit display function is activated and the traffic information detection function is not performed.

4. The display system of claim 1, wherein the control unit controls the first display unit to display that the traffic information detection function is not performed and controls the second display unit to display the second speed limit when the speed limit display function is activated and the traffic information detection function is not performed.

5. The display system of claim 1, wherein the first speed limit is obtained by recognizing a speed limit on a traffic sign located on the periphery of the vehicle.

6. The display system of claim 5, wherein the traffic information detection unit comprises:
a camera configured to take the images of surroundings of the vehicle; and
an information processing unit configured to read out information shown on the traffic sign on the periphery of the vehicle from the images taken by the camera.

7. The display system of claim 1, wherein the first display unit is a cluster displaying state information of the vehicle.

8. The display system of claim 1, wherein the second display unit is a display of the navigation of the vehicle.

9. A method of controlling a display system of a vehicle, the display system comprising a traffic information detection unit configured to take images of surroundings of a vehicle and detect a first speed limit on a road from the taken images, a first display unit configured to display the first speed limit, a second display unit configured to display a second speed limit of map data of navigation, and a speed limit display setting unit configured to activate or deactivate a speed limit display function of the first display unit, the method comprising:
not displaying the first speed limit on the first display unit and displaying the second speed limit on the second display unit when the speed limit display function of the first display unit is deactivated and a traffic information detection function of the traffic information detection unit is performed; and
displaying the first speed limit on the second display unit instead of the second speed limit when the first speed limit differs from the second speed limit.

10. The method of claim 9, further comprising:
displaying the first speed limit on the first display unit and displaying the second speed limit on the second display unit when the speed limit display function is activated and the traffic information detection function is performed,
wherein the first speed limit is displayed on the second display unit instead of the second speed limit when the first speed limit differs from the second speed limit.

11. The method of claim 9, further comprising:
displaying, on the first display unit, that the traffic information detection function is not performed and displaying the second speed limit on the second display unit when the speed limit display function is activated and the traffic information detection function is not performed.

12. The method of claim 9, wherein the first speed limit is obtained by recognizing a speed limit on a traffic sign located on the periphery of the vehicle.

13. The method of claim 12, wherein the traffic information detection unit comprises:
a camera configured to take the images of surroundings of the vehicle; and
an information processing unit configured to read out information shown on the traffic sign on the periphery of the vehicle from the images taken by the camera.

14. The method of claim 9, wherein the first display unit is a cluster displaying state information of the vehicle.

15. The method of claim 1, wherein the second display unit is a display of the navigation.

17. A vehicle comprising:
a traffic information detection unit configured to take images of surroundings of the vehicle and detect a first speed limit on a road from the taken images;
a first display unit configured to display the first speed limit;
a second display unit configured to display a second speed limit of map data of navigation;
a speed limit display setting unit configured to activate or deactivate a speed limit display function of the first display unit; and
a control unit configured to perform a plurality of control modes for controlling the first display unit to display the first speed limit and controlling the second display unit to display the second speed limit,
wherein the plurality of control modes comprise:
a first mode in which the first display unit displays the first speed limit and the second display unit displays the second speed limit when the speed limit display function is activated and a traffic information detection function is performed, and the first speed limit is displayed on the second display unit instead of the second speed limit when the first speed limit differs from the second speed limit;
a second mode in which the first display unit displays that the traffic information detection function is not performed and the second display unit displays the second speed limit when the speed limit display function is activated and the traffic information detection function is not performed;
a third mode in which the first display unit does not display the first speed limit and the second display unit displays the second speed limit when the speed limit display function is deactivated and the traffic information detection function is performed, and the first speed limit is displayed on the second display unit instead of the second speed limit when the first speed limit differs from the second speed limit; and
a fourth mode in which the first display unit displays that the traffic information detection function is not performed and the second display unit displays the second speed limit when the speed limit display function is activated and the traffic information detection function is not performed.

17. A vehicle comprising:
a traffic information detection unit configured to capture images of surroundings of the vehicle and obtain a first speed limit on a road from the captured images;
a navigation system configured to determine a position of the vehicle, and a second speed limit of map data stored in the navigation system corresponding to the determined position of the vehicle;
a first display unit configured to display or not display the first speed limit;
a second display unit configured to selectively display one of the first and second speed limits; and
a control unit configured to control the second display unit to display the first speed limit when the first speed limit differs from the second speed limit.

19. The vehicle of claim 17, further comprising a speed limit display setting unit configured to activate or deactivate a speed limit display function of the first display unit,
wherein the first display unit displays the first speed limit upon the activation of the speed limit display function, and the first display unit does not display the first speed limit upon deactivation of the speed limit display function.
